(19) United States
(12) Patent Application Publication
(10) Pub. No.: US 2025/0076101 A1
(43) Pub. Date: Mar. 6, 2025

(54) AUTOMATIC CALIBRATION OF VIBRATION SENSOR BASED ON MOUNTING METHOD

(71) Applicant: ITT Manufacturing Enterprises LLC, Wilmington, DE (US)

(72) Inventors: Bradley DeCook, Victor, NY (US); James Reitano, Farmington, NY (US)

(21) Appl. No.: 18/724,046

(22) PCT Filed: Dec. 28, 2021
(86) PCT No.: PCT/US2021/065337

§ 371 Date: Jun. 25, 2024

(51) Int. Cl. G01H 1/00

(52) U.S. Cl. CPC G01H 1/00

(57) ABSTRACT

A device and method to measure vibration of a piece of equipment. The device includes a vibration sensor, a graphic user interface, a processor, and a memory. The processor is in communication with the vibration sensor, the graphic user interface, and the memory. The processor is configured to receive an input that includes information about a method used to mount the device to the piece of equipment, determine a vibration transfer function from the memory based on the input, and apply the vibration transfer function to vibration data generated by the vibration sensor to generate calibrated vibration data.

### TECHNICAL FIELD

The present disclosure generally relates to a sensor device used to monitor a piece of equipment, such as a pump or vibrating machine.

### BACKGROUND

Unless otherwise indicated herein, the materials described in this section are not prior art to the claims in this application and are not admitted being prior art by inclusion in this section.

A sensor device may be used to monitor a piece of equipment, such as a pump or vibrating machine. A mounting connector may be used to connect the sensing device to the piece of equipment. A mounting connector may securely connect the sensing device to the piece of equipment so that sensed data is accurate.

### SUMMARY

Existing challenges associated with the foregoing, as well as other challenges, are overcome by the presently disclosed automatic calibration of a vibration sensor for sensing or detecting vibrations, such as vibrations caused by equipment, based on a method of mounting the vibration sensor to the equipment.

One embodiment of the present disclosure is a device to measure and automatically calibrate vibration measurement of a piece of equipment. The device includes a vibration sensor, a graphic user interface, a processor, and a memory. The processor is in communication with the vibration sensor, the graphic user interface, and the memory. The processor is configured to receive an input that includes information about a method used to mount the device to the piece of equipment, determine a vibration transfer function from the memory based on the input, and apply the vibration transfer function to vibration data generated by the vibration sensor to generate calibrated vibration data.

In aspects, the device further comprises a housing, and the housing includes an orifice though the housing and a stud through the orifice secures the device to the piece of equipment.

In aspects, the input includes information that the device is stud-mounted to the piece of equipment and the processor determines a stud-mount transfer function as the vibration transfer function.

In aspects, the input includes information that the device is stud-mounted to the piece of equipment and the processor stores the input in the memory and the processor determines a stud-mount transfer function as the vibration transfer function based on the input stored in the memory.

In aspects, the device further comprises a housing and a magnetic mount is attached to a bottom side of the housing.

In aspects, the input includes information that the device is magnetically-mounted to the piece of equipment and the processor determines a magnetic-mount transfer function as the vibration transfer function.

In aspects, the input includes information that the device is magnetically-mounted to the piece of equipment and the processor stores the input in the memory and the processor determines a magnetic-mount transfer function as the vibration transfer function based on the input stored in the memory.

In aspects the input includes information that the device is epoxy mounted to the piece of equipment and the processor determines an epoxy-mount transfer function as the vibration transfer function.

In aspects the input includes information that the device is epoxy-mounted to the piece of equipment, the processor stores the input in the memory, and the processor determines an epoxy-mount transfer function as the vibration transfer function based on the input stored in the memory.

In aspects, the device further comprises a transmitter and the processor is in communication with the transmitter. The processor is further configured to wirelessly transmit the calibrated vibration data to another device. The other device utilizes the calibrated vibration data to monitor equipment vibration, alarms, analytics, and/or diagnostics.

In aspects, the processor is further configured to output the calibrated vibration data on the graphic user interface to be displayed.

Another embodiment of the present disclosure includes a method for automatic calibration of a vibration sensor device. The method comprises receiving an input that includes information about a method used to mount the vibration senor device to a piece of equipment. The method comprises determining a vibration transfer function based on the input. The method comprises applying the vibration transfer function to vibration data generated by a vibration sensor of the vibration sensor device to generate calibrated vibration data.

In aspects, the method further comprises storing the input in a memory of the vibration sensor device.

In aspects, the method further comprises receiving the input through a graphic user interface of the vibration sensor device and outputting the calibrated vibration data on the graphic user interface to be displayed.

In aspects, the method further comprises wirelessly transmitting the calibrated vibration data to another device.

In aspects, the method further comprises receiving the input through a graphic user interface of the device, storing the input in a memory of the device, determining the vibration transfer function based on the input stored in the memory of the device, and wirelessly transmitting the calibrated vibration data to another device. The other device utilizes the calibrated vibration data to monitor equipment vibration, alarms, analytics, and/or diagnostics.

Another embodiment of the present disclosure is a device to measure and automatically calibrate vibration of a piece of equipment. The device comprises a housing, a vibration sensor, a graphic user interface, a processor, a memory, and a transmitter. The processor is in communication with the vibration sensor, the graphic user interface, the memory, and the transmitter. The processor is configured to receive an input through the graphic user interface. The input includes information about a method used to mount the device to the piece of equipment. The processor is configured to store the input in the memory and determine a vibration transfer function from the memory based on the input stored in the memory. The processor is configured to apply the vibration transfer function to vibration data generated by the vibration sensor to generate calibrated vibration data and to wirelessly transmit the calibrated vibration data to another device and/or output the calibrated vibration data on the graphic user interface to be displayed.

The foregoing summary is illustrative only and is not intended to be in any way limiting. In addition to the illustrative aspects, embodiments, and features described above, further aspects, embodiments, and features will become apparent by reference to the drawings and the following detailed description and appended claims.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a side perspective view of a vibration sensor stud-mounted to a piece of equipment in accordance with the present disclosure;

FIG. 2A is a graph of Gain versus Frequency for a Vibration Frequency Response for a stud-mounted vibration sensor in accordance with the present disclosure;

FIG. 2B is a graph of Gain versus Frequency for a Transfer Function for a stud-mounted vibration sensor in accordance with the present disclosure;

FIG. 2C is a graph of Gain versus Frequency for a Vibration Frequency Response for a stud-mounted vibration sensor calibrated with a Transfer Function in accordance with the present disclosure;

FIG. 3 is a side perspective view of a vibration sensor magnetically-mounted to a piece of equipment in accordance with the present disclosure;

FIG. 4A is a graph of Gain versus Frequency for a Vibration Frequency Response for a magnetically-mounted vibration sensor in accordance with the present disclosure;

FIG. 4B is a graph of Gain versus Frequency for a Transfer Function for a magnetically-mounted vibration sensor in accordance with the present disclosure;

FIG. 4C is a graph of Gain versus Frequency for a Vibration Frequency Response for a magnetically-mounted vibration sensor calibrated with a Transfer Function in accordance with the present disclosure;

FIG. 5 is a side perspective view of a vibration sensor directly epoxy-mounted to a piece of equipment in accordance with the present disclosure; and

FIG. 6A is a graph of Gain versus Frequency for a Vibration Frequency Response for an epoxy-mounted vibration sensor in accordance with the present disclosure;

FIG. 6B is a graph of Gain versus Frequency for a Transfer Function for an epoxy-mounted vibration sensor in accordance with the present disclosure;

FIG. 6C is a graph of Gain versus Frequency for a Vibration Frequency Response for an epoxy-mounted vibration sensor calibrated with a Transfer Function in accordance with the present disclosure;

FIG. 7 is a flow diagram of an example process to automatically calibrate a vibration sensor based on its mounting method in accordance with the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

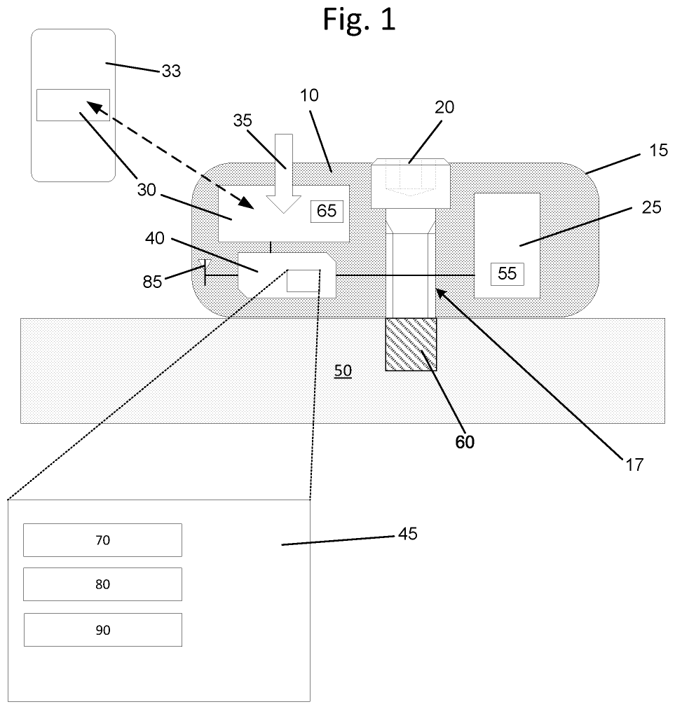

FIG. 1 is a side perspective view of a vibration sensor stud-mounted to a piece of equipment in accordance with the present disclosure and arranged in accordance with at least some embodiments described herein. A vibration sensor device 10 may include housing 15, a vibration sensor 25, a graphic user interface 30, a processor 40, a memory 45, and a transmitter 85. Vibration sensor 25 may be an accelerometer and may sense or detect vibrations. Vibration sensor device 10 may be mounted on a piece of equipment 50 with a stud 20. Stud 20 may be placed through an orifice 17 of housing 15 of vibration sensor device 10 and thread within an orifice 60 of equipment 50 to secure or mount vibration sensor device 10 to piece of equipment 50. Stud mounting of vibration sensor device 10 to piece of equipment 50 may be direct screw mount or adapted screw mount.

Processor 40 may be in communication with vibration sensor 25, graphic user interface 30, memory 45, and transmitter 85. While graphic user interface 30 is shown as part of vibration sensor device 10, it is contemplated and within the scope of the disclosure that graphic user interface 30 may be part of a smart device 33, separate from vibration sensor device 10, and processor 40 may be in communication with smart device 33 through transmitter 85. Vibration sensor 25 may output sensed vibration data 55 to processor 40. Graphic user interface 30 may allow a user to provide inputs 35 to processor 40 of vibration sensor device 10, such as initial set up and configuration, operation settings, and vibration sensor device 10 output settings. Graphic user interface 30 may allow a user to provide an input 35 indicating a mounting method used to secure or mount vibration sensor device 10 to piece of equipment 50. Processor 40 may be configured to receive input 35 through graphic user interface 30. Memory 45 may include instructions for a stud-mount transfer function 70 for vibration frequency response for a stud-mounted vibration sensor, instructions for a magnetic-mount transfer function 80 for vibration frequency response for a magnetically-mounted vibration sensor, and instructions for an epoxy-mount transfer function 90 for vibration frequency response for a directly epoxy-mounted vibration sensor. Stud-mount transfer function 70 may include a direct screw mount transfer function and/or an adapted screw mount transfer function.

Processor 40 may calibrate output 65 of vibration sensor device 10 based on input 35 of mounting method from graphic user interface 30 and stud-mount transfer function 70, magnetic-mount transfer function 80, or epoxy-mount transfer function 90 from memory 45. Calibrated output 65 may be a vibration measurement of machine 50. For example, when input 35 indicates that the method used to mount vibration senor device 10 to piece of equipment 50 was stud mounting (as shown in FIG. 1), processor 40 may determine stud-mount transfer function 70 be applied to output sensed vibration data 55 to produce calibrated output 65. In another example, when input 35 indicates that the method used to mount vibration senor device 10 to piece of equipment 50 was magnetic mounting, processor 40 may determine magnetic-mount transfer function 80 be applied to output sensed vibration data 55 to produce calibrated output 65. In another example, when input 35 indicates that the method used to mount vibration senor device 10 to piece of equipment 50 was direct epoxy mounting, processor 40 may determine epoxy-mount transfer function 90 be applied to output sensed vibration data 55 to produce calibrated output 65. Calibrated output 65 may be displayed on graphic user interface 30 and/or may be wirelessly transmitted to another device by transmitter 85. Calibrated output 65 may be wirelessly transmitted to another device by transmitter 85 and the other device may utilize calibrated output 65 for monitoring of equipment vibration, alarms, analytics, and/or diagnostics.

Processor 40 may store input 35 in memory 45. Input 35 may be stored in memory 45 as a setting of vibration sensor device 10. Processor 40 may calibrate output 65 of vibration sensor device 10 based on input 35 stored in memory 45.

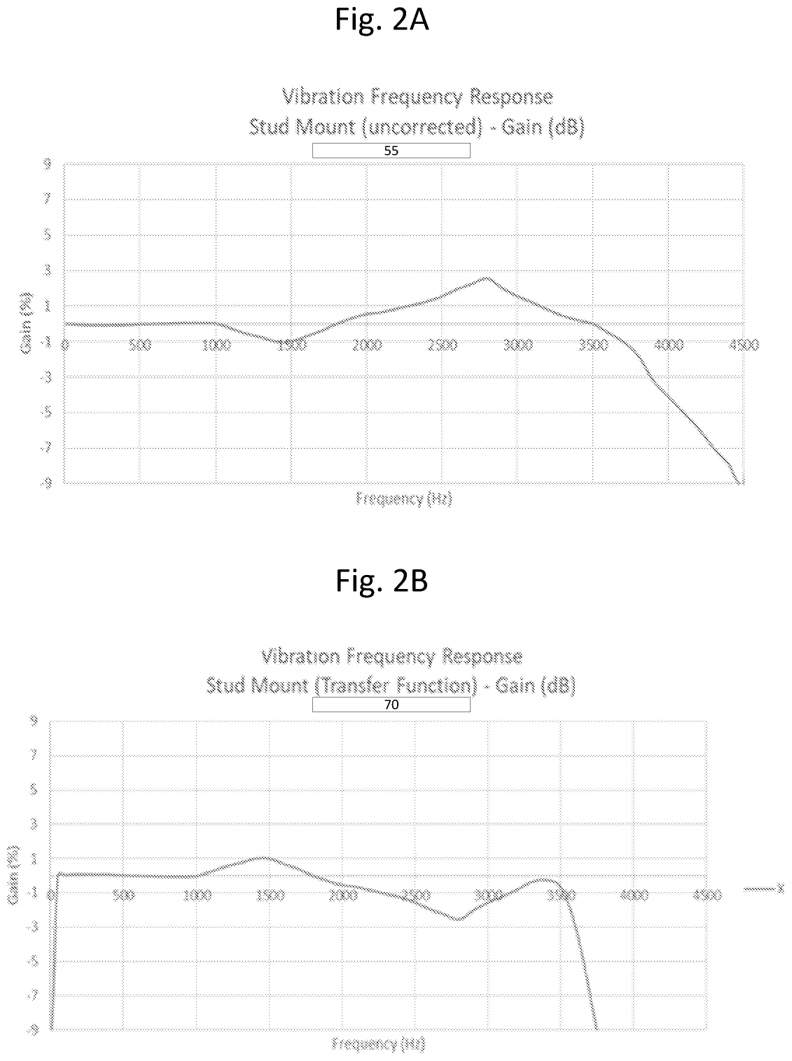

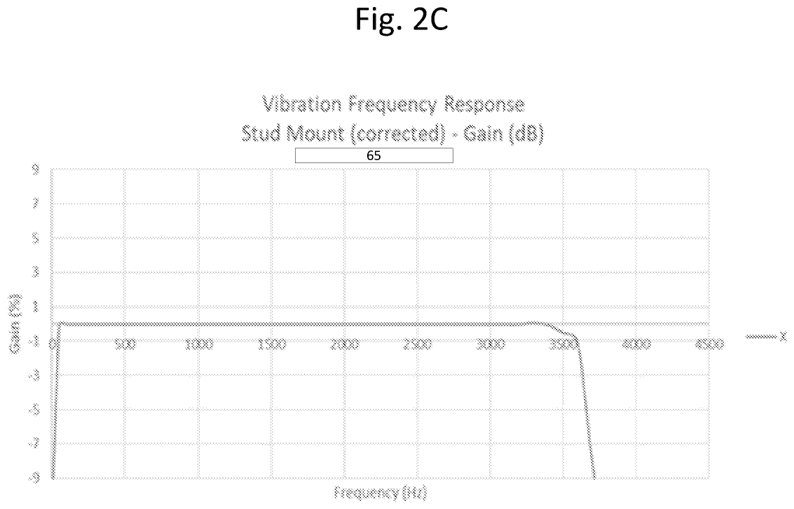

FIG. 2A is a graph of Gain versus Frequency for a Vibration Frequency Response for a stud-mounted vibration sensor in accordance with the present disclosure and arranged in accordance with at least some embodiments described herein. Those components in FIG. 2A that are labeled identically to components of FIG. 1 will not be described again for the purposes of brevity.

FIG. 2A depicts a graph for a Vibration Frequency Response of a stud-mounted vibration sensor such as output sensed vibration data 55 of vibration sensor device 10 of FIG. 1. The gain in decibels (dB) is shown on the y-axis and frequency in hertz (Hz) is shown on the x-axis. As shown in FIG. 2A, a vibration frequency response from a stud mounted vibration sensor may be essentially linear within a vibration frequency range up to about 1000 Hz and may skew down or up at various vibration frequencies above 1000 Hz.

FIG. 2B is a graph of Gain versus Frequency for a Transfer Function for a stud-mounted vibration sensor, arranged in accordance with at least some embodiments described herein. Those components in FIG. 2B that are labeled identically to components of FIG. 1-2A will not be described again for the purposes of brevity.

FIG. 2B depicts a graphical representation of stud-mount transfer function 70 for a Vibration Frequency Response of a stud-mounted vibration sensor such as vibration sensor device 10 of FIG. 1. The gain in decibels (dB) is shown on the y-axis and frequency in hertz (Hz) is shown on the x-axis. As shown in FIG. 2B, a stud-mount transfer function 70 for a vibration frequency response of a stud mounted vibration sensor may be essentially linear within a vibration frequency range up to about 1000 Hz and may be designed to calibrate a vibration frequency response for a stud mounted vibration sensor at vibration frequencies above 1000 Hz. Stud-mount transfer function 70 may include a co-efficient array determined by performing a frequency response sweep using a feedback controlled, calibrated vibration shaker system for a stud mounted vibration sensor.

FIG. 2C is a graph of Gain versus Frequency for a Vibration Frequency Response for a stud-mounted vibration sensor calibrated with a Transfer Function, arranged in accordance with at least some embodiments described herein. Those components in FIG. 2C that are labeled identically to components of FIG. 1-2B will not be described again for the purposes of brevity.

FIG. 2C depicts a graph of calibrated Gain versus Frequency for a Vibration Frequency Response of a stud-mounted vibration sensor such as calibrated output 65 of vibration sensor device 10 of FIG. 1. The gain in decibels (dB) is shown on the y-axis and frequency in hertz (Hz) is shown on the x-axis. As shown in FIG. 2C, when stud-mount transfer function 70 is applied to sensed vibration data 55 (FIG. 2B) of a stud-mounted vibration sensor, the resulting gain in decibels is essentially linear in a frequency range up to about 3300 Hz. Calibration of sensed vibration data 55 of a stud-mounted vibration sensor by applying stud-mount transfer function 70 may improve accuracy and reliability of vibration data provided by stud-mounted vibration sensor device 10.

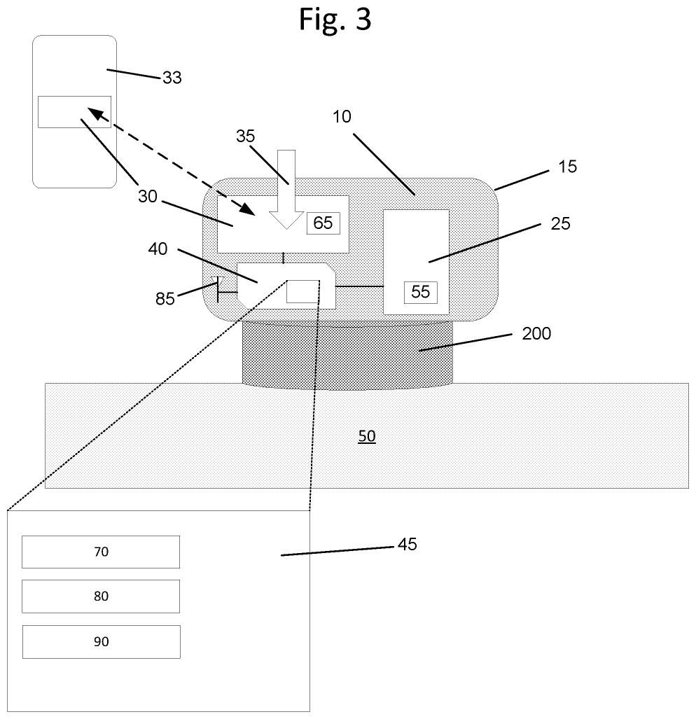

FIG. 3 is a side perspective view of a vibration sensor magnetically-mounted to a piece of equipment, arranged in accordance with at least some embodiments described herein. Those components in FIG. 3 that are labeled identically to components of FIG. 1-2C will not be described again for the purposes of brevity.

A vibration sensor device 10 may be mounted on a piece of equipment 50 with a magnetic mount 200. As previously detailed, vibration sensor device 10 may include housing 15, vibration sensor 25, graphic user interface 30, processor 40, memory 45, and transmitter 85. Magnetic mount 200 may be attached to a bottom side of housing 15 of vibration sensor device 10 and may secure vibration sensor device 10 to a metal surface of piece of equipment 50.

Processor 40 may be in communication with vibration sensor 25, graphic user interface 30, memory 45, and transmitter 85. As previously stated, graphic user interface 30 may be part of a smart device 33, separate from vibration sensor device 10, and processor 40 may be in communication with smart device 33 through transmitter 85. Vibration sensor 25 may output sensed vibration data 55 to processor 40. Graphic user interface 30 may allow a user to provide an input 35 indicating a mounting method used to vibration sensor device 10 to piece of equipment 50. Processor 40 may be in communication with memory 45 which may include stud-mount transfer function 70, magnetic-mount transfer function 80, and epoxy-mount transfer function 90.

Processor 40 may calibrate output 65 of vibration sensor device 10 based on input 35 of mounting method from graphic user interface 30 and stud-mount transfer function 70, magnetic-mount transfer function 80, or epoxy-mount transfer function 90 from memory 45. For example, when input 35 indicates that the method used to mount vibration senor device 10 to piece of equipment 50 was magnetic mounting (as shown in FIG. 3), processor 40 may determine magnetic-mount transfer function 80 be applied to output sensed vibration data 55 to produce calibrated output 65. In another example, when input 35 indicates that the method used to mount vibration senor device 10 to piece of equipment 50 was stud mounting, processor 40 may determine stud-mount transfer function 70 be applied to output sensed vibration data 55 to produce calibrated output 65. In another example, when input 35 indicates that the method used to mount vibration senor device 10 to piece of equipment 50 was direct epoxy mounting, processor 40 may determine epoxy-mount transfer function 90 be applied to output sensed vibration data 55 to produce calibrated output 65. Calibrated output 65 may be displayed on graphic user interface 30 and/or may be wirelessly transmitted to another device by transmitter 85.

Processor 40 may store input 35 in memory 45. Input 35 may be stored in memory 45 as a setting of vibration sensor device 10. Processor 40 may calibrate output 65 of vibration sensor device 10 based on input 35 stored in memory 45.

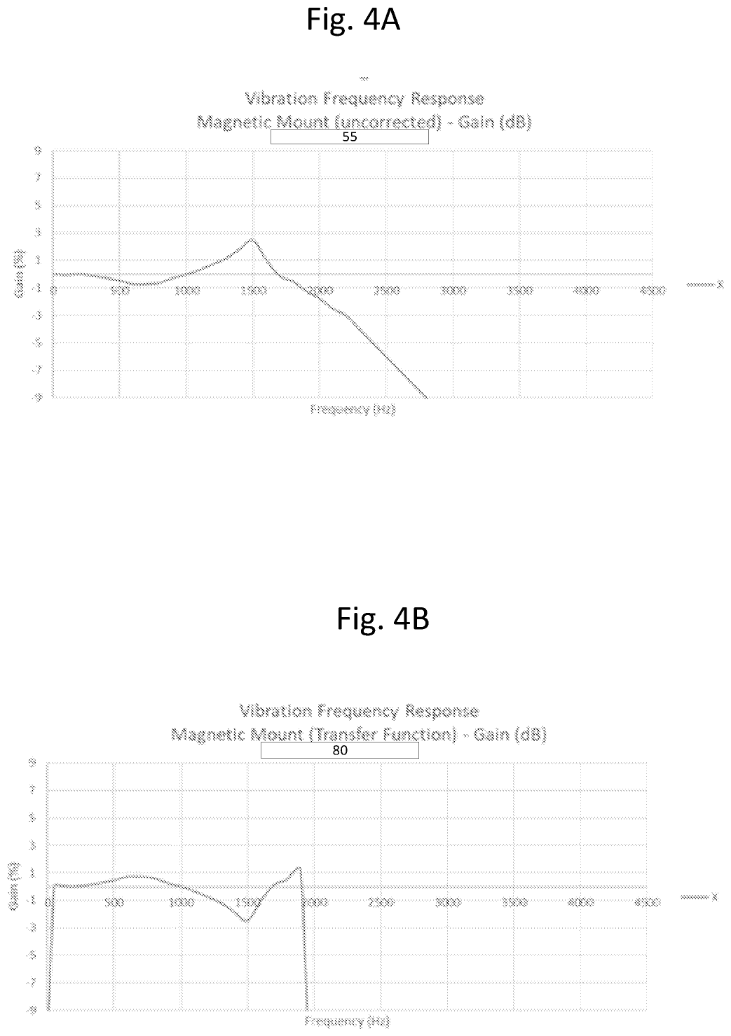

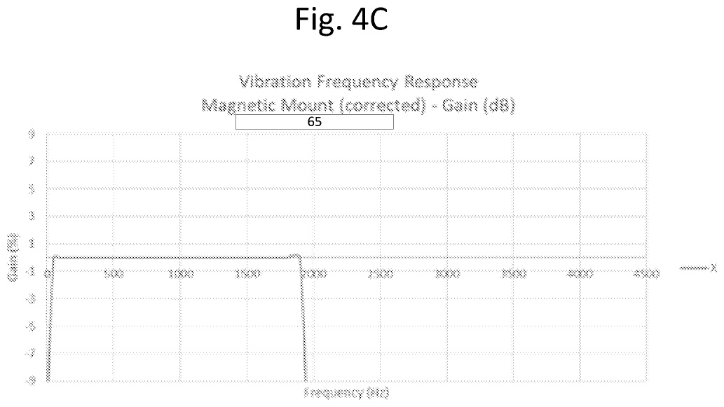

FIG. 4A is a graph of Gain versus Frequency for a Vibration Frequency Response for a magnetically-mounted vibration sensor, arranged in accordance with at least some embodiments described herein. Those components in FIG. 4A that are labeled identically to components of FIG. 1-3 will not be described again for the purposes of brevity.

FIG. 4A depicts a graph for a Vibration Frequency Response of a magnetically-mounted vibration sensor such as vibration sensor device 10 of FIG. 3. The gain in decibels (dB) is shown on the y-axis and frequency in hertz (Hz) is shown on the x-axis. As shown in FIG. 4A, a vibration frequency response from a magnetically mounted vibration sensor may be somewhat linear within a vibration frequency range up to about 300 Hz and may skew down or up at various vibration frequencies above 300 Hz.

FIG. 4B is a graph of Gain versus Frequency for a Transfer Function for a magnetically-mounted vibration sensor, arranged in accordance with at least some embodiments described herein. Those components in FIG. 4B that are labeled identically to components of FIG. 1-4A will not be described again for the purposes of brevity.

FIG. 4B depicts a graphical representation of magnetic-mount transfer function 80 for a Vibration Frequency Response of a magnetic-mounted vibration sensor such as vibration sensor device 10 of FIG. 3. The gain in decibels (dB) is shown on the y-axis and frequency in hertz (Hz) is shown on the x-axis. As shown in FIG. 4B, a magnetic-mount transfer function 80 for a vibration frequency response of a magnetically mounted vibration sensor may be essentially linear within a vibration frequency range up to about 300 Hz and may be designed to calibrate a vibration frequency response for a magnetically mounted vibration sensor at vibration frequencies above 300 Hz. Magnetic-mount transfer function 80 may include a co-efficient array determined by performing a frequency response sweep using a feedback controlled, calibrated vibration shaker system for a magnetically mounted vibration sensor.

FIG. 4C is a graph of Gain versus Frequency for a Vibration Frequency Response for a magnetically-mounted vibration sensor calibrated with a Transfer Function, arranged in accordance with at least some embodiments described herein. Those components in FIG. 4C that are labeled identically to components of FIG. 1-4B will not be described again for the purposes of brevity.

FIG. 4C depicts a graph of calibrated Gain versus Frequency for a Vibration Frequency Response of a magnetically-mounted vibration sensor such as vibration sensor device 10 of FIG. 3. The gain in decibels (dB) is shown on the y-axis and frequency in hertz (Hz) is shown on the x-axis. As shown in FIG. 4C, when magnetic-mount transfer function 80 is applied to calibrate a Vibration Frequency Response of a magnetically-mounted vibration sensor, the resulting gain in decibels is essentially linear in a frequency range up to about 1800 Hz. Calibration of Vibration Frequency Response of a magnetically-mounted vibration sensor may be performed by applying magnetic-mount transfer function 80 to vibration data output by magnetically-mounted vibration sensor device 10 and may improve accuracy and reliability of vibration data provided by magnetic-mounted vibration sensor device 10.

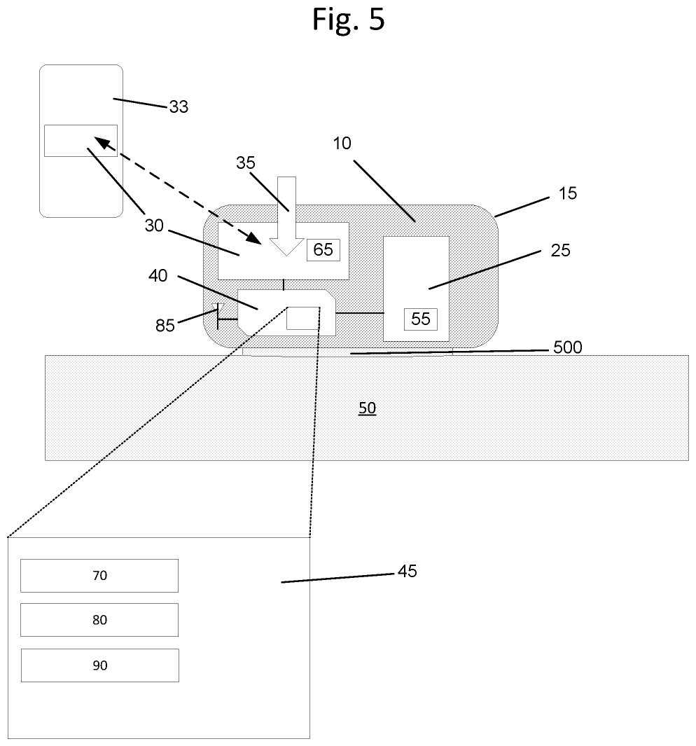

FIG. 5 is a side perspective view of a vibration sensor directly epoxy-mounted to a piece of equipment, arranged in accordance with at least some embodiments described herein. Those components in FIG. 5 that are labeled identically to components of FIG. 1-4C will not be described again for the purposes of brevity.

A vibration sensor device 10 may be directly mounted on a piece of equipment 50 with an epoxy mount 500. As previously detailed, vibration sensor device 10 may include housing 15, vibration sensor 25, graphic user interface 30, processor 40, memory 45, and transmitter 85. Epoxy mount 500 may be a layer of epoxy directly applied to a bottom side of housing 15 of vibration sensor device 10 and a metal surface of piece of equipment 50 and may secure vibration sensor device 10 to metal surface of piece of equipment 50 when epoxy mount 500 cures.

Processor 40 may be in communication with vibration sensor 25, graphic user interface 30, memory 45, and transmitter 85. As previously stated, graphic user interface 30 may be part of a smart device 33, separate from vibration sensor device 10, and processor 40 may be in communication with smart device 33 through transmitter 85. Vibration sensor 25 may output sensed vibration data 55 to processor 40. Graphic user interface 30 may allow a user to provide an input 35 indicating a mounting method used to vibration sensor device 10 to piece of equipment 50. Processor 40 may be in communication with memory 45 which may include stud-mount transfer function 70, magnetic-mount transfer function 80, and epoxy-mount transfer function 90.

Processor 40 may calibrate output 65 of vibration sensor device 10 based on input 35 of mounting method from graphic user interface 30 and stud-mount transfer function 70, magnetic-mount transfer function 80, or epoxy-mount transfer function 90 from memory 45. For example, when input 35 indicates that the method used to mount vibration senor device 10 to piece of equipment 50 was direct epoxy mounting (as shown in FIG. 5), processor 40 may determine epoxy-mount transfer function 90 be applied to output sensed vibration data 55 to produce calibrated output 65. Epoxy-mount transfer function 90 may include a co-efficient array determined by performing a frequency response sweep using a feedback controlled, calibrated vibration shaker system for an epoxy mounted vibration sensor. In another example, when input 35 indicates that the method used to mount vibration senor device 10 to piece of equipment 50 was stud mounting, processor 40 may determine stud-mount transfer function 70 be applied to output sensed vibration data 55 to produce calibrated output 65. In another example, when input 35 indicates that the method used to mount vibration senor device 10 to piece of equipment 50 was magnetic mounting, processor 40 may determine magnetic-mount transfer function 80 be applied to output sensed vibration data 55 to produce calibrated output 65. Calibrated output 65 may be displayed on graphic user interface 30 and/or may be wirelessly transmitted to another device by transmitter 85.

Processor 40 may store input 35 in memory 45. Input 35 may be stored in memory 45 as a setting of vibration sensor device 10. Processor 40 may calibrate output 65 of vibration sensor device 10 based on input 35 stored in memory 45.

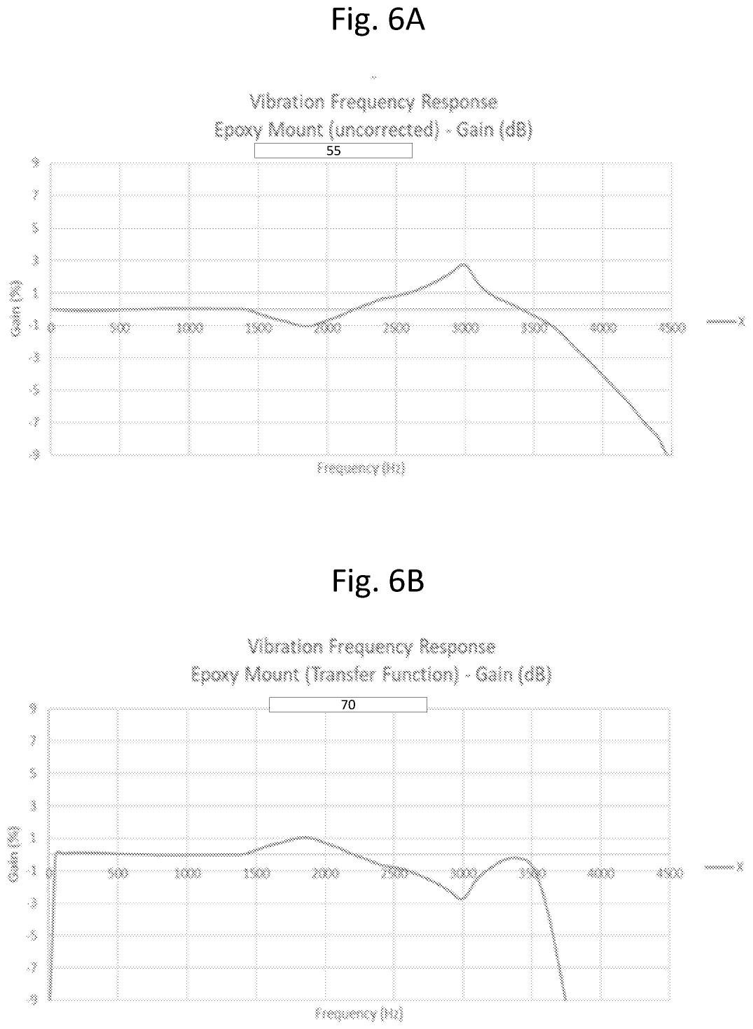

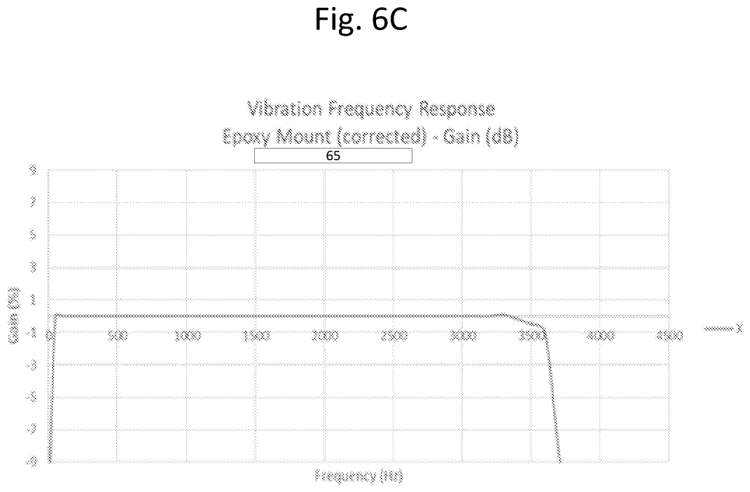

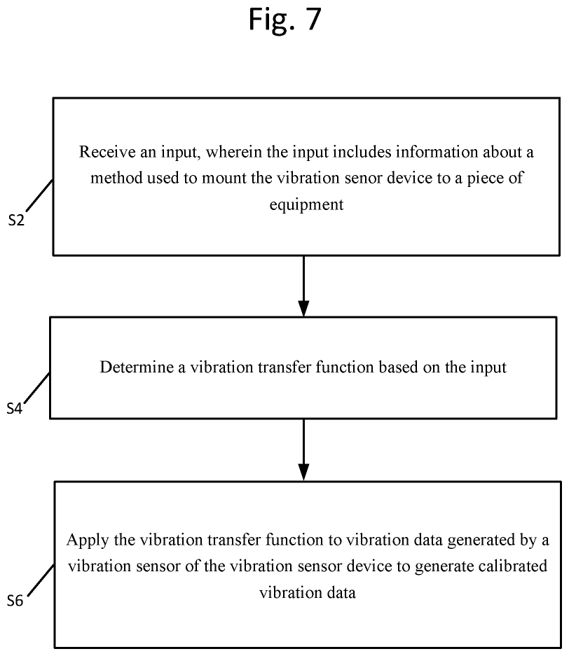

FIG. 6A is a graph of Gain versus Frequency for a Vibration Frequency Response for an epoxy mounted vibration sensor in accordance with the present disclosure and arranged in accordance with at least some embodiments described herein. Those components in FIG. 6A that are labeled identically to components of FIGS. 1-5 will not be described again for the purposes of brevity.

FIG. 6A depicts a graph for a Vibration Frequency Response of an epoxy-mounted vibration sensor such as output sensed vibration data 55 of vibration sensor device 10 of FIG. 5. The gain in decibels (dB) is shown on the y-axis and frequency in hertz (Hz) is shown on the x-axis. As shown in FIG. 6A, a vibration frequency response from an epoxy mounted vibration sensor may be essentially linear within a vibration frequency range up to about 1400 Hz and may skew down or up at various vibration frequencies above 1000 Hz.

FIG. 6B is a graph of Gain versus Frequency for a Transfer Function for an epoxy mounted vibration sensor, arranged in accordance with at least some embodiments described herein. Those components in FIG. 6B that are labeled identically to components of FIG. 1-6A will not be described again for the purposes of brevity.

FIG. 6B depicts a graphical representation of epoxy-mount transfer function 90 for a Vibration Frequency Response of an epoxy mounted vibration sensor such as vibration sensor device 10 of FIG. 5. The gain in decibels (dB) is shown on the y-axis and frequency in hertz (Hz) is shown on the x-axis. As shown in FIG. 6B, an epoxy-mount transfer function 90 for a vibration frequency response of an epoxy mounted vibration sensor may be essentially linear within a vibration frequency range up to about 1400 Hz and may be designed to calibrate a vibration frequency response for a stud mounted vibration sensor at vibration frequencies above 1400 Hz. Epoxy-mount transfer function 90 may include a co-efficient array determined by performing a frequency response sweep using a feedback controlled, calibrated vibration shaker system for an epoxy mounted vibration sensor.

FIG. 6C is a graph of Gain versus Frequency for a Vibration Frequency Response for an epoxy mounted vibration sensor calibrated with a Transfer Function, arranged in accordance with at least some embodiments described herein. Those components in FIG. 6C that are labeled identically to components of FIG. 1-6B will not be described again for the purposes of brevity.

FIG. 6C depicts a graph of calibrated Gain versus Frequency for a Vibration Frequency Response of an epoxy mounted vibration sensor such as calibrated output 65 of vibration sensor device 10 of FIG. 5. The gain in decibels (dB) is shown on the y-axis and frequency in hertz (Hz) is shown on the x-axis. As shown in FIG. 6C, when epoxy-mount transfer function 90 is applied to sensed vibration data 55 (FIG. 6B) of an epoxy mounted vibration sensor, the resulting gain in decibels is essentially linear in a frequency range up to about 3300 Hz. Calibration of sensed vibration data 55 of an epoxy mounted vibration sensor by applying epoxy-mount transfer function 90 may improve accuracy and reliability of vibration data provided by epoxy mounted vibration sensor device 10.

A device in accordance with the present disclosure may provide a user with more accurate vibration data. A device in accordance with the present disclosure may account for variances in a vibration sensing device that are based on different mounting configurations of the vibration sensing device. A device in accordance with the present disclosure may provide a user with more accurate vibration data over a greater range or frequencies. A device in accordance with the present disclosure may provide a user with more accurate vibration data at higher frequencies than other devices. A device in accordance with the present disclosure may provide more accurate vibration data at higher frequencies for more accurate alarms or diagnostics.

FIG. 6 illustrates a flow diagram for an example process to mount a device that includes a rigid mounting connector, arranged in accordance with at least some embodiments presented herein. An example process may include one or more operations, actions, or functions as illustrated by one or more of blocks S2, S4, and/or S6. Although illustrated as discrete blocks, various blocks may be divided into additional blocks, combined into fewer blocks, or eliminated, depending on the desired implementation.

Processing may begin at block S2, “Receive an input, wherein the input includes information about a method used to mount the vibration senor device to a piece of equipment.” At block S2, a processor of a vibration sensor device may receive an input from a graphic user interface of the vibration sensor device. The graphic user interface may allow a user of the vibration sensor device to input a method used to mount the vibration sensor device. The input received by the processor may include information about a method used to mount the vibration senor device to a piece of equipment.

Processing may continue from block S2 to block S4, “Determine a vibration transfer function based on the input.” At block S4, the processor may determine a vibration transfer function based on the input. The processor may be in communication with a memory of the vibration sensor device and the memory may include a stud-mount transfer function and a magnetic-mount transfer function. For example, when the input indicates that the method used to mount the vibration senor device to a piece of equipment was stud mounting, the processor may determine vibration transfer function to be applied is stud-mount transfer function. In another example, when the input indicates that the method used to mount the vibration senor device to a piece of equipment was magnetic mounting, the processor may determine vibration transfer function to be applied is magnetic-mount transfer function.

Processing may continue from block S4 to block S6, “Apply the vibration transfer function to vibration data generated by a vibration sensor of the vibration sensor device to generate calibrated vibration data.” At block S6, the processor may apply the determined vibration transfer function to vibration data generated by a vibration sensor of the vibration sensor device. Application of the determined transfer function to vibration data generated by a vibration sensor of the vibration sensor device may calibrate the output vibration data and may improve an accuracy, reliability, and frequency range of the vibration sensing device.

It should be understood the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

1. A device to measure and automatically calibrate vibration measurement of a piece of equipment, the device comprising:
a vibration sensor;
a graphic user interface;
a processor; and
a memory;
wherein the processor is in communication with the vibration sensor, the graphic user interface, and the memory and is configured to:
receive an input, wherein the input includes information about a method used to mount the device to the piece of equipment;
determine a vibration transfer function from the memory based on the input; and
apply the vibration transfer function to vibration data generated by the vibration sensor to generate calibrated vibration data.

2. The device of claim 1, further comprising a housing, wherein the housing includes an orifice though the housing and a stud through the orifice secures the device to the piece of equipment.

3. The device of claim 2, wherein the input includes information that the device is stud-mounted to the piece of equipment and the processor determines a stud-mount transfer function as the vibration transfer function.

4. The device of claim 2, wherein the input includes information that the device is stud-mounted to the piece of equipment, the processor stores the input in the memory, and the processor determines a stud-mount transfer function as the vibration transfer function based on the input stored in the memory.

5. The device of claim 1, further comprising:
a housing; and
a magnetic mount attached to a bottom side of the housing.

6. The device of claim 5, wherein the input includes information that the device is magnetically-mounted to the piece of equipment and the processor determines a magnetic-mount transfer function as the vibration transfer function.

7. The device of claim 5, wherein the input includes information that the device is magnetically-mounted to the piece of equipment, the processor stores the input in the memory, and the processor determines a magnetic-mount transfer function as the vibration transfer function based on the input stored in the memory.

8. The device of claim 2, wherein the input includes information that the device is epoxy mounted to the piece of equipment and the processor determines an epoxy-mount transfer function as the vibration transfer function.

9. The device of claim 2, wherein the input includes information that the device is epoxy mounted to the piece of equipment, the processor stores the input in the memory, and the processor determines an epoxy-mount transfer function as the vibration transfer function based on the input stored in the memory.

10. The device of claim 1, further comprising a transmitter, wherein the processor is in communication with the transmitter, and the processor is further configured to wirelessly transmit the calibrated vibration data to another device wherein the other device utilizes the calibrated vibration data to monitor equipment vibration, alarms, analytics, and/or diagnostics.

11. The device of claim 1, wherein the processor is further configured to output the calibrated vibration data on the graphic user interface to be displayed.

12. A method for automatic calibration of a vibration sensor device, the method comprising:
receiving an input, wherein the input includes information about a method used to mount the vibration senor device to a piece of equipment;
determining a vibration transfer function based on the input; and
applying the vibration transfer function to vibration data generated by a vibration sensor of the vibration sensor device to generate calibrated vibration data.

13. The method of claim 12, further comprising storing the input in a memory of the vibration sensor device.

14. The method of claim 12, further comprising:
receiving the input through a graphic user interface of the vibration sensor device; and
outputting the calibrated vibration data on the graphic user interface to be displayed.

15. The method of claim 12, further comprising wirelessly transmitting the calibrated vibration data to another device, wherein the other device utilizes the calibrated vibration data to monitor equipment vibration, alarms, analytics, and/or diagnostics.

16. The method of claim 12, further comprising:
receiving the input through a graphic user interface of the device;
storing the input in a memory of the device;
determining the vibration transfer function based on the input stored in the memory of the device; and
transmitting the calibrated vibration data to another device.

17. A device to measure and automatically calibrate vibration of a piece of equipment, the device comprising:
a housing;
a vibration sensor;
a graphic user interface;
a processor;
a memory; and
a transmitter
wherein the processor is in communication with the vibration sensor, the graphic user interface, the memory, and the transmitter and is configured to:
receive an input through the graphic user interface, wherein the input includes information about a method used to mount the device to the piece of equipment;
store the input in the memory;
determine a vibration transfer function from the memory based on the input stored in the memory;
apply the vibration transfer function to vibration data generated by the vibration sensor to generate calibrated vibration data; and
wirelessly transmit the calibrated vibration data to another device and/or output the calibrated vibration data on the graphic user interface to be displayed.

18. The device of claim 17, wherein the input includes information that the device is stud-mounted to the piece of equipment and the processor determines a stud-mount transfer function as the vibration transfer function.

19. The device of claim 17, wherein the input includes information that the device is magnetically-mounted to the piece of equipment and the processor determines a magnetic-mount transfer function as the vibration transfer function.

20. The device of claim 17, wherein the input includes information that the device is epoxy-mounted to the piece of equipment and the processor determines an epoxy-mount transfer function as the vibration transfer function.
